(19) United States
(12) Patent Application Publication
(10) Pub. No.: US 2007/0297425 A1
(43) Pub. Date: Dec. 27, 2007

(54) SYSTEMS AND METHODS FOR ESTABLISHING A NETWORK OVER A SUBSTATION DC/AC CIRCUIT

(76) Inventor: George Chirco, North Brunswick, NJ (US)

Correspondence Address: SUTHERLAND ASBILL & BRENNAN LLP, 999 PEACHTREE STREET, N.E., ATLANTA, GA, 30309, US

(21) Appl. No.: 11/426,182

(22) Filed: Jun. 23, 2006

(51) Int. Cl. H04L 12/56

(52) U.S. Cl. 370/401

(57) ABSTRACT

A system and method for transmitting data within a utility substation in which a utility substation power line coupled to a voltage source is used to power a gateway and one or more network devices. The gateway generates a network signal that is communicated onto the power line by a first coupler and received by a second coupler. The second coupler then transmits the received network signal to one or more network devices configured to collect data relating to the operation of the utility substation.

### FIELD OF THE INVENTION

The present invention relates generally to systems and methods in which a data network is established in a utility substation.

### BACKGROUND OF THE INVENTION

There are many devices present in a utility substation, including various measurement and substation control devices. It is often desirous to collect data from these devices for analysis. The analyzed data can then be used to assist in the control of the substation. In order to collect the data, the substation devices must be able to communicate with a supervisory control and data acquisition (SCADA) system or with a remote network controller.

Typically, installing a utility substation for SCADA applications requires hardwiring communication cables between the devices and a network data controller. Because many utility substations are metal clad outdoor facilities, wiring would have to be run through the substation, and more than likely would have to be trenched or buried in the substation. Running and trenching wires are expensive network solutions, and at least in the field of electrical power utilities, they are often subject to restrictions based on safety policies and guidelines. Alternative network solutions, such as radio and Wi-Fi networks, are relatively costly and create network security issues. If a substation network is breached, then the substation could be effectively shut down.

Therefore, there exist a need in the art for a cost-effective substation network capable of collecting data from substation devices and transmitting that data to a SCADA or network controller.

### SUMMARY OF THE INVENTION

According to one embodiment of the invention, there is disclosed a data network for transmitting data within a utility substation. The data network includes a power line coupled to a voltage source and a gateway that generates a network signal. The network signal is at a frequency greater than approximately one MHz and it is communicated onto the power line by a first coupler associated with the gateway. A second coupler in communication with the power line and associated with at least one network device detects the network signal on the power line and communicates the network signal to one or more network devices. The one or more network devices receive power from the power line and collect data relating to the operation of the substation which is used to generate a data signal. The data signal is then coupled onto the power line by the second coupler.

According to another embodiment of the invention, there is disclosed a method for transmitting data within a utility substation. A voltage signal is provided to a power line and a network signal, which is powered by the power line, generates a network signal that is at a frequency greater than approximately one MHz. The network signal is coupled to the power line with a first coupler and transmitted over the power line to second coupler configured to receive the network signal and transmit the network signal to at least one network device, wherein the at least one network device is powered by the power line and configured to generate a data signal relating to the operation of the utility substation. The data signal is then transmitted to the second coupler and communicated onto the power line.

Aspects of the invention described below apply to both the data network for transmitting data within a utility substation and to the method for transmitting data within a utility substation. According to one aspect of the present invention, the first coupler is further configured to detect the data signal on the power line and transmit the data signal to the gateway, wherein a network connection is established between the gateway and the at least one network device. According to another aspect of the present invention, the network connection established between the gateway and the at least one network device is a point to point protocol. According to yet another aspect of the invention, the network signal generated by the gateway is within a frequency range of approximately 2 to 20 MHz. Similarly, the data signal generated by the one or more network devices may be within the same frequency range of approximately 2 to 20 MHz. According to another aspect of the present invention, the generated network signal permits data to be transmitted over the power line according to a TCP/IP or UDP protocol. According to yet another aspect of the present invention, the network signal is encrypted on the network. Similarly, the data signal may be encrypted on the network.

According to yet another aspect of the present invention, the power source providing a voltage to the power line is a direct current power source. Alternatively, the power source may be an alternating current power source. According to another aspect of the invention, the power source generates a voltage signal in a range of approximately 24 to 250 volts.

According to another aspect of the present invention, the gateway is also connected to a computer terminal, wherein the gateway may transmit data collected on or concerning the BPL network to the computer terminal. According to yet another aspect of the present invention, the gateway may be connected to a hub or a router. The gateway may transmit data collected on or concerning the BPL network onto a wide area network such as the Internet via the hub or the router.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of a data network in a utility substation, according to an illustrative embodiment of the present invention.

FIG. 2 is an exemplary flowchart of the procedure for communicating information over a BPL network, according to an embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention comprises systems and methods for establishing a data network within a utility substation utilizing Broadband Over Power Line (BPL) technology. BPL technology is a type of powerline communications (PLC). BPL generally refers to a type of communication in which broadband Internet traffic is carried over power lines, as will be understood by those of ordinary skill in the art. In accordance with BPL technology, an REF data signal is typically transmitted over a power line which also carries a power signal at a lower frequency than the RF data signal.

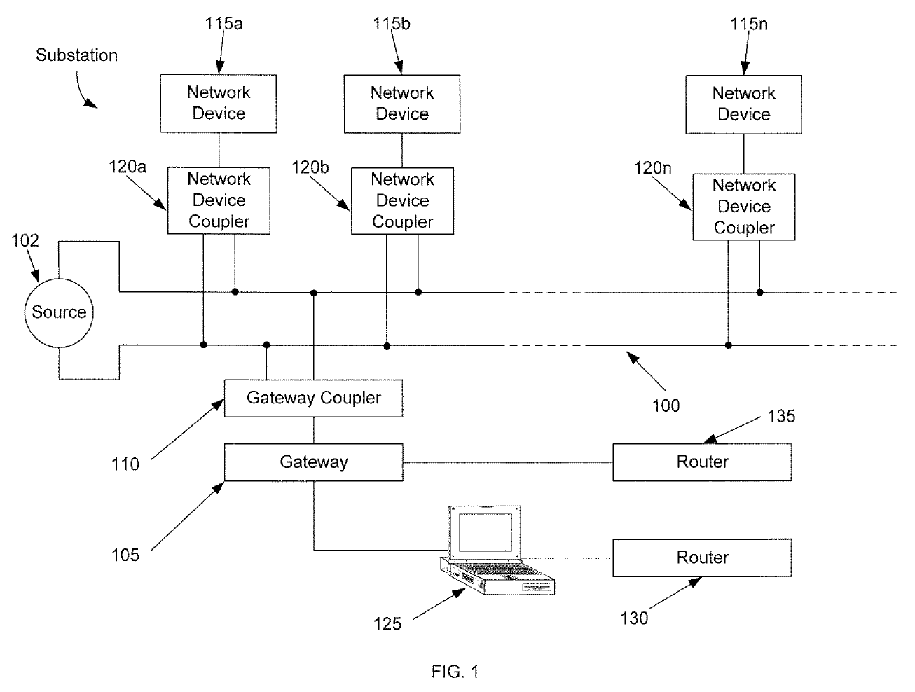

FIG. 1 is a schematic diagram of a BPL network in a utility substation, according to an illustrative embodiment of the present invention. A power line 100 within a utility substation may be used as a network line that connects the other network devices. According to an aspect of the invention, an Ethernet network may be created on the power line 100. A voltage source 102 may be used to generate a voltage on the power line 100. The voltage source 102 may be a battery, a voltage generator, an outside source connected to the utility substation, or any other voltage source as will be understood by those of skill in the art. The frequency

According to one embodiment of the invention, the power line 100 may carry an alternating current (AC) within the utility substation that is generated by a source 102. The AC voltage generated by the source 102 may be a low voltage, medium voltage, or high voltage signal. A medium voltage signal may be a signal between approximately 600 and 40,000 volts and a high voltage signal may be greater than approximately 40,000 volts. In accordance with an aspect of the present invention, the source 102 generates AC power that may be a low voltage signal of approximately 24-250 volts. It will be understood, however, that the low voltage AC power signal may be a signal of approximately 24-600 volts. The frequency of the signal generated by the source 102 may be a low frequency signal, such as a signal at 50 or 60 Hz. The power line 100 used to create a BPL network may be an AC power line that is already present within the utility substation.

According to a second embodiment of the invention, the power line 100 may be a direct current (DC) line within the utility substation. Thus, the BPL network may be transmitted over a DC power line, such as power line 100, wherein the voltage source 102 provides DC power such as a low voltage of approximately 24-250 volts. The DC power line 100 may be the same line used within the utility substation to power the substation in the event of power outages and tripped circuits. Therefore, establishing the BPL network over the DC power line 100 provides a reliable network because there is a minimal chance of power loss. In the event of a loss of power to the substation, generators or batteries may be used to provide DC power to the equipment within the substation. If the BPL network is established over the DC power line 100 used to power the substation equipment, the BPL network will still be operable in the event of a power outage.

Devices in the utility substation that are connected to the BPL network may be powered by the power line 100. Accordingly, in a first embodiment of the present invention, the devices in the utility substation may be powered by an AC power line, where the AC power line is also used to transmit data signals over the BPL network. Similarly, in a second embodiment of the present invention, the devices in the utility substation may be powered by a DC power line, where the DC power line is also used to transmit data signals over the BPL network. It will also be understood by those of ordinary skill in the art that substation and network devices may be powered by an AC power line in the substation while a DC power line is used to transmit data over the BPL network. Alternatively, substation and network devices may be powered by a DC power line in the substation while an AC power line is used to transmit data over the BPL network.

According to an aspect of the present invention, a gateway 105 may be used to generate a RF network signal over the power line 100. The gateway 105 may be a Telkonet Gateway PPG2500, or another suitable device capable of generating an RF signal. The gateway 105 may be configured to be powered by either an AC or a DC power source 102. Additionally, the gateway 105 may be configured to generate a signal for transmission over either an AC or a DC power line 100. The generated signal may be a low voltage signal. For example, the low voltage signal may be at a voltage of approximately 0.1 to 20 volts. Additionally, this signal may be a signal at or above 1 MHz. According to an aspect of the present invention, the generated signal may be in a range of approximately 2 to 20 MHz, although it will be understood by those of skill in the art that other frequencies may be used, such as a frequency in the range of approximately 2 to 40 MHz or a frequency that is greater than 40 MHz. The frequency of the signal generated by the gateway 105 may be selected by the gateway 105 in order to reduce noise on the power line 100 or to avoid interference with other signals present on the power line 100.

The generated RF signal may be used to transmit data over the power line 100 using a TCP/IP or a UDP protocol; however, it will be understood by those of ordinary skill in the art that other network protocols may be used in accordance with the present invention. A gateway coupler 110 may be used to connect the gateway 105 to the power line 100. The gateway 105 may be connected to the gateway coupler 110 with a coaxial cable, or by some other method of transmitting broadband signals. The gateway coupler 110 may also be referred to as an injector, and it may be directly connected to the power line 100 in order to transfer or communicate the signal generated by the gateway 105 onto the power line 100. Alternatively, the gateway coupler 110 may be an inductive coupler that transfers or communicates the signal generated by the gateway 105 onto the power line 100. In its alternative embodiment, the gateway coupler 110 may transfer the signal onto the power line 100 by wrapping around the power line 100, without directly connecting to the power line 100. Through the gateway coupler 110, the gateway 105 may drive and control the BPL network over the power line 100.

According to another aspect of the invention, one or more network devices 115a-n may be present in the utility substation. The network devices 115a-n may be powered by either an AC or a DC power source 102. These network devices 115a-n may be intelligent electronic devices (IEDs) that collect data pertaining to and provide control over the operation of the substation. The network devices 115a-n may include protective relaying devices, load tap changer controllers, circuit breaker controllers, capacitor bank switches, recloser controllers, voltage regulators, or other microprocessor-based controllers of power system equipment. The network devices 115a-n may be connected to the power line 100 by network device couplers 120a-n, respectively. Each network device coupler 120a-n may be a Telkonet iBridge™, or any other suitable device capable of coupling a network device to a power line. The network device couplers 120a-n may be configured to connect the network devices 115a-n to either an AC or a DC power line 100. A single network device coupler 120 may connect each network device 115 to the power line 100. The network device couplers 120a-n allow the network devices 115a-n to receive the signal generated by the gateway 105 and to transmit data over the BPL network to one another or to the gateway 105. The data transmitted over the BPL network by the network device couplers 120a-n may be transmitted at the same frequency as the network signal generated by the gateway 105.

According to another aspect of the invention, the gateway 105 controls and manages the data on the BPL network. The gateway 105 may collect data transmitted on the network by the network devices 115a-n through the network device couplers 120a-n. According to an aspect of the present invention, the connection between a network device 115 and a gateway 105 is a point to point protocol. The BPL network may be established so that no two network devices 115a-n will be capable of communicating with each other directly over the network without the approval of the gateway 105; however, any two network devices 115a-n may be capable of communicating with each other through a connection established by the gateway 105. In this manner, a proprietary network may be established so that no other device connected to the power line 100 may break into or hack into the BPL network. The gateway 105 may also establish a simple network management protocol (SNMP) on the BPL network. According to another aspect of the invention, the gateway 105 may control encryption keys on the network, as will be understood by those of ordinary skill in the art. These encryption keys may be updated manually at the gateway 105, or they may be updated remotely.

According to yet another aspect of the present invention, the gateway 105 may be connected to a computer terminal 125 that may be located at or remote to the utility substation. The gateway 105 may communicate data to the computer terminal 125 for storage or for communication onto a wide area network 130 such as the Internet. Alternatively, the gateway 105 may be connected to a hub or router 135 capable of transmitting data through a wide area network such as the Internet. By using a connection established through a computer terminal 125, router 135 or hub, the gateway 105 may transmit or communicate data collected from or relating to the BPL network and/or the operation of the substation to a location situated remotely with respect to the utility substation. The remote location may be a corporate network that is monitoring the BPL network and/or the substation. Alternatively, the remote location may be a supervisory control and data acquisition (SCADA) system, as will be understood by those of skill in the art.

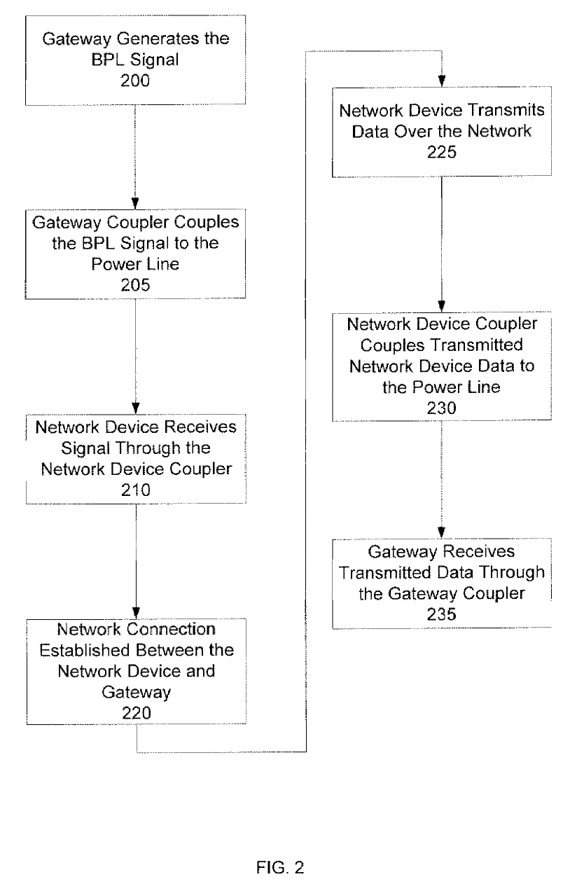

FIG. 2 is an exemplary flowchart of the procedure for communicating information over a BPL network, according to an embodiment of the present invention. At step 200, the gateway 105 generates the BPL signal which is used to create the BPL network over the power line 100. Then, at step 205, the gateway coupler 110 couples the generated BPL signal onto the power line 100. At step 210, a network device 115 may receive the generated BPL signal through a network device coupler 120. Once the network device 115 receives the BPL signal, a network connection may be established between the gateway 105 and the network device 115 at step 220. This network connection may be a point to point protocol.

As previously mentioned, the network devices 115a-n may be IEDs which collect data pertaining to the control and operation of the substation. Accordingly, a network device 115 may collect substation data and transmit that collected data over the BPL network at step 225. At step 230, a network device coupler 120 couples the data transmitted by the network device 115 onto the power line 100. Then, at step 235, the gateway 105 may receive, by way of the gateway coupler 110, the data transmitted by the network device 115 onto the power line 100. Once the gateway 105 receives data from a network device 115, the gateway may communicate or transmit the received data to a computer terminal 125 or to a hub our router 135, which is capable of communicating the data over a wide area network such as the Internet.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A data network for transmitting data within a utility substation, comprising:
a utility substation power line coupled to a voltage source;
a gateway that generates a network signal, wherein the network signal is at a frequency greater than approximately one megahertz (MHz);
a first coupler associated with the gateway that receives and communicates the network signal onto the power line;
at least one network device receiving power from the power line, and configured to collect data relating to the operation of the utility substation and to generate a data signal based on the collected data;
a second coupler associated with the at least one network device and in communication with the power line, the second coupler configured to detect the network signal on the power line and provide the network signal to the network device and to receive the data signal generated by the at least one network device and to communicate the data signal onto the power line.

2. The data network of claim 1, further comprising:
the first coupler being further configured to detect the data signal on the power line and to transmit the data signal to the gateway;
wherein a network connection is established between the gateway and the at least one network device.

3. The data network of claim 2, wherein the network connection established between the at least one network device and the gateway is a point to point protocol.

4. The data network of claim 1, wherein the network signal is within a frequency range of approximately 2 to 20 MHz.

5. The data network of claim 1, wherein the power source is an alternating current power source.

6. The data network of claim 1, wherein the power source is a direct current power source.

7. The data network of claim 1, wherein the power source generates a voltage signal in a range of approximately 24 to 250 volts.

8. The data network of claim 1, wherein the network signal permits data to be transmitted over the power line according to one of a TCP/IP or a UDP protocol.

9. The data network of claim 1, wherein the network signal is encrypted on the network.

10. The data network of claim 1, further comprising:
a computer terminal connected to the gateway;
wherein the gateway transmits data to the computer terminal.

11. The data network of claim 1, further comprising:
a hub or a router connected to the gateway;
wherein the gateway transmits data onto a wide area network via the hub or the router.

12. A method for generating a data network within a utility substation, comprising:
providing a voltage signal to a power line;
generating a network signal with a gateway, wherein the gateway is powered by the power line and the generated network signal is at a frequency greater than approximately one megahertz (MHz);
coupling the network signal to the power line with a first coupler; and
transmitting the network signal over the power line to a second coupler configured to receive the network signal and transmit the network signal to at least one network device, wherein the at least one network device is powered by the power line.

13. The method of claim 1, further comprising:
generating a data signal relating to the operation of the utility substation with the at least one network device;
transmitting the data signal from the least one network device to the second coupler;
coupling the data signal to the power line with the second coupler;
receiving the data signal at the first coupler; and
transmitting the data signal from the first coupler to the gateway;
wherein a network connection is established between the gateway and the at least one network device.

14. The method of claim 12, wherein generating a network signal comprising generating a network signal within a frequency range of approximately 2 to 20 MHz.

15. The method of claim 12, wherein the voltage signal is an alternating current voltage signal.

16. The method of claim 12, wherein the voltage signal is a direct current voltage signal.

17. The method of claim 12, wherein the voltage signal is in a range of approximately 24 to 250 volts.

18. The method of claim 12, wherein the network signal permits data to be transmitted over the power line according to one of a TCP/IP or a UDP protocol.

19. The method of claim 12, wherein the network signal is encrypted on the network.

20. The method of claim 12, further comprising:
connecting the gateway to one or more of a computer terminal or a huh or a router; and
transmitting the data signal from the gateway to the computer terminal or onto a wide area network via the hub or router.
